(19) United States
(12) Patent Application Publication
(10) Pub. No.: US 2009/0247157 A1
(43) Pub. Date: Oct. 1, 2009

(54) FEMTO CELL SYSTEM SELECTION

(75) Inventors: Young C. Yoon, San Diego, CA (US); Srinivasan Balasubramanian, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/410,767

(22) Filed: Mar. 25, 2009

Related U.S. Application Data
(60) Provisional application No. 61/040,297, filed on Mar. 28, 2008.

(51) Int. Cl. H04W 4/00

(52) U.S. Cl. 455/434; 455/435.1; 455/435.2

(57) ABSTRACT

Systems and methodologies are described that facilitate identifying and/or selecting femto cells in a wireless communication environment. A mobile device can scan an Auxiliary Pilot Channel to detect auxiliary pilot channel information (e.g., a particular Walsh Code, . . . ) sent from a base station. Moreover, the identified auxiliary pilot channel information can be evaluated to detect a characteristic of the base station. For instance, the identified auxiliary pilot channel information can be compared with stored auxiliary pilot channel information (e.g., Walsh Code(s) included in a whitelist, blacklist, . . . ). Moreover, a Synchronization Channel can be read based upon the detected characteristic. Further, a Common Pilot Channel, for example, can be analyzed to search for pseudo-noise (PN) offset(s) reserved for femto cell base stations, and the scan of the Auxiliary Pilot Channel can be initiated in response to detecting at least one reserved PN offset.

### CLAIM OF PRIORITY UNDER 35 U.S.C. §119

The present Application for Patent claims priority to Provisional Application No. 61/040,297 entitled “FEMTO CELL SYSTEM SELECTION” filed Mar. 28, 2008, and assigned to the assignee hereof and hereby expressly incorporated by reference herein.

### BACKGROUND

1. Field

The following description relates generally to wireless communications, and more particularly to detecting and/or selecting femto cells in a wireless communication environment.

2. Background

Wireless communication systems are widely deployed to provide various types of communication content such as, for example, voice, data, and so on. Typical wireless communication systems can be multiple-access systems capable of supporting communication with multiple users by sharing available system resources (e.g., bandwidth, transmit power, . . . ). Examples of such multiple-access systems can include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), and/or multi-carrier wireless specifications such as evolution data optimized (EV-DO), one or more revisions thereof, etc.

Generally, wireless multiple-access communication systems can simultaneously support communication for multiple mobile devices. Each mobile device can communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations can be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

Wireless communication systems commonly can include various types of base stations, each of which can be associated with differing cell sizes. For instance, macro cell base stations typically leverage antenna(s) installed on masts, rooftops, other existing structures, or the like. Further, macro cell base stations oftentimes have power outputs on the order of tens of watts, and can provide coverage for large areas. The femto cell base station is another class of base station that has recently emerged. Femto cell base stations are commonly designed for residential or small business environments, and can provide wireless coverage to mobile devices using existing broadband Internet connections (e.g., digital subscriber line (DSL), cable, . . . ). A femto cell base station can also be referred to as a Home Node B (HNB), a femto cell, or the like.

According to an example scenario, a mobile device can move between differing geographic locations, and the differing geographic locations can be covered by one or more disparate base stations. For instance, the mobile device can be in a coverage area associated with a first base station at a first time and a second base station at a second time. As the position of the mobile device changes, it can be advantageous for the mobile device to recognize femto cell base station(s) accessible by the mobile device. The mobile device can access a personal femto cell base station (e.g. associated with a user/account of the mobile device, . . . ), a femto cell base station of a friend, neighbor, etc. of the user of the mobile device, and the like. By way of illustration, a femto cell base station can be preferred to a macro cell base station due to respective billing techniques commonly associated with corresponding communication therewith (e.g., communication leveraging a macro cell base station can be charged as a function of usage time while communication leveraging a femto cell base station can be a flat rate charge, . . . ).

Conventional techniques utilized by mobile devices for identifying and/or selecting a femto cell base station are oftentimes inefficient and time consuming. For instance, a mobile device can incur significant battery power consumption (e.g., associated with modem receiver operation, . . . ), delay, and so forth in connection with common femto cell system selection. Conventional approaches oftentimes can include reading one (or more) broadcast channels (e.g., Sync Channel, . . . ) to determine whether a mobile device is in a coverage area of a macro cell base station or a femto cell base station. Reading an over-the-air message sent via a broadcast channel, however, can be costly (e.g. reducing battery life, introducing time delays, . . . ) since such approach commonly includes a plurality of steps (e.g., tuning to a frequency band, tuning to a pseudo-noise (PN) offset, . . . ) prior to being able to obtain the broadcast message. Further, upon finding a femto cell base station, the mobile device typically determines if the femto cell base station allows access (e.g., open association, . . . ) or denies access (e.g., restricted access for private usage, . . . ) by attempting registration.

A common approach that has been utilized to allow a base station to advertise that it is a femto cell base station rather than a disparate type of base station (e.g., macro cell base station, . . . ) involves reserving a set of pseudo-noise (PN) offsets for femto cell base stations. The set of PN offsets can be reserved by a cellular operator. Further, a PN offset is a physical layer parameter that identifies a sector or a cell. Various problems, however, are associated with the aforementioned approach. For instance, with such approach, a mobile device typically needs to read the Sync Channel and/or attempt to register with a particular base station to determine whether the base station is a valid femto cell base station on which it can camp. Moreover, the foregoing example can involve re-provisioning and/or reconfiguring of the PN offsets of the macro cell network. Moreover, to minimize impact on the macro network, operators may prefer to minimize a number of PN offsets reserved for femto cell base stations; for instance, operators may desire to have no explicit femto PN offsets. Another deficiency with the aforementioned approach is that when a PN offset scan is performed, a mobile device typically selects a strongest pilot and reads the Sync Channel for only that pilot, while remaining strong pilot(s) (if any) are often ignored. Accordingly, an ability of the mobile device to identify potential femto cell base stations in its vicinity can be limited. Further, when a neighboring, restricted, strong femto cell base station is in vicinity of a home femto cell base station for a mobile device, the mobile device can be prevented from finding its desired home femto cell base station.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more embodiments and corresponding disclosure thereof, various aspects are described in connection with identifying and/or selecting femto cells in a wireless communication environment. A mobile device can scan an Auxiliary Pilot Channel to detect auxiliary pilot channel information (e.g., a particular Walsh Code, . . . ) sent from a base station. Moreover, the identified auxiliary pilot channel information can be evaluated to detect a characteristic of the base station. For instance, the identified auxiliary pilot channel information can be compared with stored auxiliary pilot channel information (e.g., Walsh Code(s) included in a whitelist, blacklist, . . . ). Moreover, a Synchronization Channel can be read based upon the detected characteristic. Further, a Common Pilot Channel, for example, can be analyzed to search for pseudo-noise (PN) offset(s) reserved for femto cell base stations, and the scan of the Auxiliary Pilot Channel can be initiated in response to detecting at least one reserved PN offset.

According to related aspects, a method is described herein. The method can include scanning an Auxiliary Pilot Channel to identify auxiliary pilot channel information sent from a base station. Further, the method can include comparing the identified auxiliary pilot channel information with stored auxiliary pilot channel information to detect a characteristic of the base station. Moreover, the method can comprise reading a broadcast channel that provides general base station identity related information based upon the detected characteristic of the base station.

Another aspect relates to a wireless communications apparatus. The wireless communications apparatus can include at least one processor. The at least one processor can be configured to collect information sent by a base station via a physical layer broadcast channel. Moreover, the at least one processor can be configured to detect at least one of a type of the base station, an association type supported by the base station, or a unique identity that distinguishes the base station from disparate base stations as a function of the collected information obtained via the physical layer broadcast channel.

Yet another aspect relates to a wireless communications apparatus. The wireless communications apparatus can include means for recognizing a received Walsh Code from a scan of an Auxiliary Pilot Channel. Further, the wireless communications apparatus can comprise means for evaluating the received Walsh Code to identify a characteristic of a broadcasting base station. Moreover, the wireless communications apparatus can include means for selecting to read a Synchronization (Sync) Channel as a function of the identified characteristic.

Still another aspect relates to a computer program product that can comprise a computer-readable medium. The computer-readable medium can include code for causing at least one computer to analyze an Auxiliary Pilot Channel to identify auxiliary pilot channel information sent from a base station. Moreover, the computer-readable medium can include code for causing at least one computer to compare the identified auxiliary pilot channel information with stored auxiliary pilot channel information to detect a characteristic of the base station. Further, the computer-readable medium can include code for causing at least one computer to read a broadcast channel that provides general base station identity related information based upon the detected characteristic of the base station.

Yet another aspect relates to an apparatus that can include an auxiliary pilot detection component that scans a physical layer broadcast channel to identify physical layer broadcast channel information sent by a base station. The apparatus can further include a comparison component that evaluates the received physical layer broadcast channel information to recognize at least one characteristic of the base station by comparing the received physical layer broadcast channel information to stored physical layer broadcast channel information. Moreover, the apparatus can include a registration component that initiates registration with the base station as a function of the at least one characteristic.

In accordance with other aspects, a method is described herein. The method can include selecting a Walsh Code from a set of Walsh Codes as a function of a characteristic of a base station. Moreover, the method can include generating a unique Auxiliary Pilot based upon the selected Walsh Code. Further, the method can comprise broadcasting the unique Auxiliary Pilot to at least one mobile device to indicate the characteristic.

Another aspect relates to a wireless communications apparatus. The wireless communications apparatus can include at least one processor. The at least one processor can be configured to generate an Auxiliary Pilot based upon a Walsh Code from a Walsh Code space assigned to a base station. Moreover, the at least one processor can be configured to transmit the Auxiliary Pilot to one or more mobile devices to designate a characteristic of the base station as a function of the assigned Walsh Code.

Yet another aspect relates to a wireless communications apparatus. The wireless communications apparatus can include means for obtaining an assigned Walsh Code at a base station. Further, the wireless communications apparatus can include means for yielding a unique Auxiliary Pilot as a function of the assigned Walsh Code. Moreover, the wireless communications apparatus can include means for transmitting the unique Auxiliary Pilot to one or more mobile devices to identify a characteristic of the base station.

Still another aspect relates to a computer program product that can comprise a computer-readable medium. The computer-readable medium can include code for causing at least one computer to generate a unique Auxiliary Pilot based upon an assigned Walsh Code, the Walsh Code being assigned as a function of a characteristic of a base station. The computer-readable medium can also include code for causing at least one computer to broadcast the unique Auxiliary Pilot to at least one mobile device to indicate the characteristic.

Yet another aspect relates to an apparatus that can include a common pilot generation component that yields a pilot sequence with a particular pseudo-noise (PN) offset reserved for femto cell base stations for transmission from a base station to at least one mobile device. The apparatus can further include an auxiliary pilot generation component that yields information related to the base station for transmission via a physical layer broadcast channel, the information specifies at least one of the base station is a femto cell base station, an association type of the base station, or a unique identifier of the base station.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example system that enables deployment of access point base stations (e.g. femto cell base stations, . . . ) within a network environment.

FIG. 3 is an illustration of an example system that supports efficient femto cell system selection in a wireless communication environment.

FIG. 4 is an illustration of an example Walsh Code tree in accordance with various aspects described herein.

FIG. 5 is an illustration of an example system that leverages Common Pilots and Auxiliary Pilots for femto cell system identification and selection in a wireless communication environment.

FIG. 6 is an illustration of an example system that employs Auxiliary Pilots to identify characteristics associated with femto cell base stations in a wireless communication environment.

FIG. 7 is an illustration of an example methodology that facilitates detecting a femto cell base station in a wireless communication environment.

FIG. 8 is an illustration of an example methodology that facilitates disseminating femto cell base station related information to one or more mobile devices in a wireless communication environment.

FIG. 9 is an illustration of an example mobile device that evaluates an Auxiliary Pilot Channel to recognize characteristics of a base station in a wireless communication system.

FIG. 10 is an illustration of an example system that provides information utilized for system identification and/or detection in a wireless communication environment.

FIG. 11 is an illustration of an example wireless network environment that can be employed in conjunction with the various systems and methods described herein.

FIG. 12 is an illustration of an example system that enables detecting a femto cell base station in a wireless communication environment.

FIG. 13 is an illustration of an example system that enables broadcasting identification information used for system selection in a wireless communication environment.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal can be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station can be utilized for communicating with wireless terminal(s) and can also be referred to as an access point, a Node B, an Evolved Node B (eNode B, eNB), a femto cell, a pico cell, a micro cell, a macro cell, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA) and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. Further, CDMA2000 covers IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and Ultra Mobile Broadband (UMB) are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits access terminals in terms of transmit power efficiency. Accordingly, SC-FDMA can be implemented as an uplink multiple access scheme in 3GPP Long Term Evolution (LTE) or Evolved UTRA.

Various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

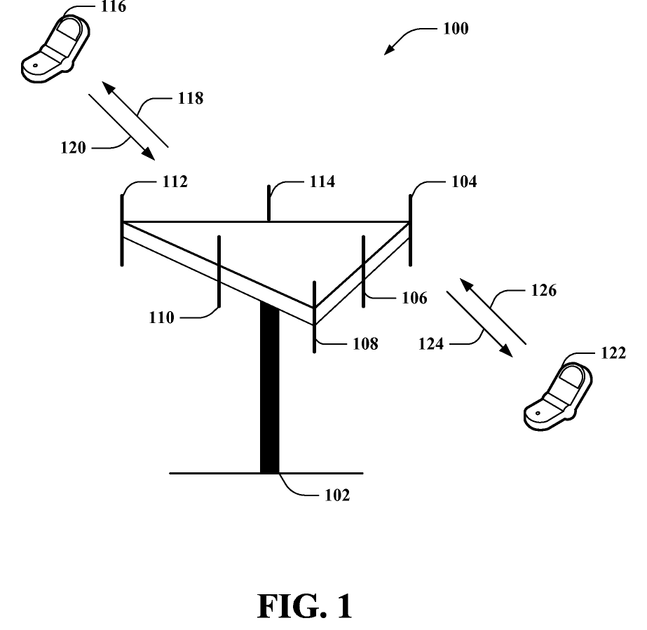

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver 081193 chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices.

Base station 102 can utilize a physical layer broadcast channel to indicate various characteristics associated therewith to mobile devices 116, 122. By way of example, the physical layer broadcast channel can be a 1 times Radio Transmission Technology (1× RTT) Auxiliary Pilot Channel, a UMTS Secondary Common Pilot Channel, a femto pilot transmitted via a physical layer broadcast control channel, and so forth. For instance, base station 102 can indicate a base station type (e.g., femto cell base station versus macro cell base station, . . . ) to mobile devices 116, 122 utilizing the physical layer broadcast channel. According to an illustration, other base station types can be specified via the physical layer broadcast channel such as, for instance, a micro cell base station, a pico cell base station, and the like. Moreover, if base station 102 is a femto cell base station, the physical layer broadcast channel can be utilized to specify an association type (e.g., open usage, restricted private usage, signaling, . . . ) corresponding to base station 102 to mobile devices 116, 122. Further, the physical layer broadcast channel can be leveraged to signify to mobile devices 116, 122 a finer level of granularity to help distinguish femto cell base station 102 from disparate femto cell base station(s) (not shown). Utilization of the physical layer broadcast channel as described herein can enable mobile devices 116, 122 to quickly determine whether base station 102 is a femto cell base station (versus a disparate type of base station), an association type of base station 102, an identity of base station 102, and so forth. In contrast to the foregoing, conventional techniques for conveying and/or recognizing such information can cause mobile devices 116, 122 to incur greater battery power consumption, access delay, and the like since each mobile device 116, 122 typically would initially read a Sync Channel and possibly perform registration (e.g., oftentimes being denied, . . . ). Examples of conventional techniques include use of an enhanced preferred roaming list (PRL), a pilot beacon, or a generalized neighbor list message (e.g., off frequency search, . . . ), yet these techniques leverage reading the Sync Channel as described above.

It is contemplated that the techniques described herein can be applied to systems employing substantially any access technology. Although many of the examples described herein relate to 3GPP2 CDMA2000 systems, it is to be appreciated that the described approaches can be extended to substantially any other access technologies such as, but not limited to, CDMA systems (e.g., 3GPP2, 3GPP, . . . ), OFDM systems (e.g., UMB, WiMAX, LTE, . . . ), and so forth.

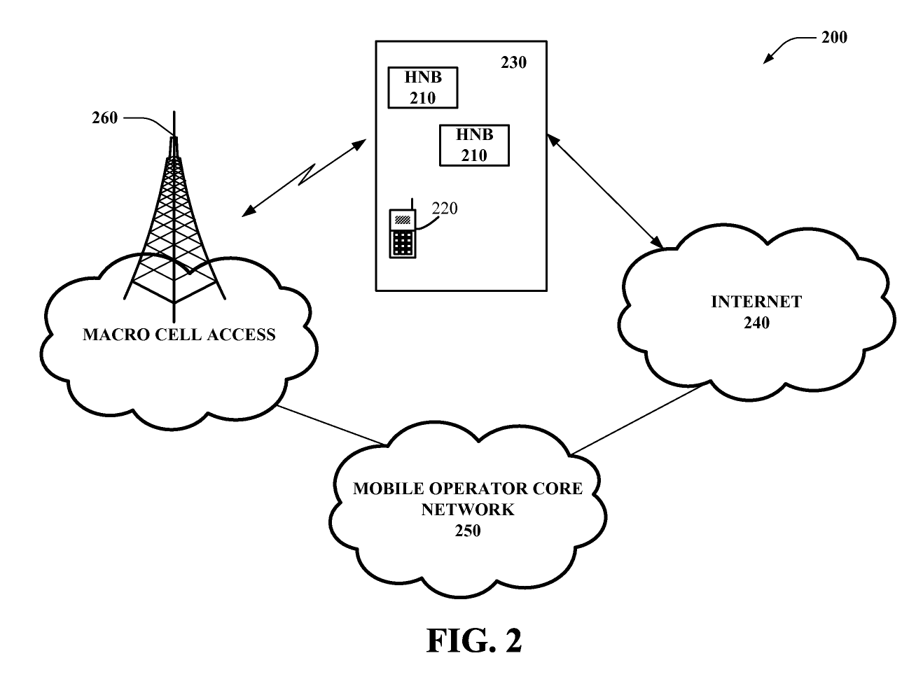

FIG. 2 illustrates an exemplary communication system 200 that enables deployment of access point base stations (e.g. femto cell base stations, . . . ) within a network environment. As shown in FIG. 2, system 200 includes multiple femto cell base stations, which can also be referred to as access point base stations, Home Node B units (HNBs), femto cells, or the like. The femto cell base stations (HNBs 210), for example, can each be installed in a corresponding small scale network environment, such as, for example, in one or more user residences 230, and can each be configured to serve associated, as well as alien, mobile device(s) 220. Each HNB 210 is further coupled to the Internet 240 and a mobile operator core network 250 via a DSL router (not shown) or, alternatively, a cable modem (not shown).

Although embodiments described herein use 3GPP terminology, it is to be understood that the embodiments may be applied to 3GPP (Rel99, Rel5, Rel6, Rel7) technology, as well as 3GPP2 (1× RTT, 1× EV-DO Rel0, RevA, RevB) technology and other known and related technologies. In such embodiments described herein, the owner of HNB 210 subscribes to mobile service, such as, for example, 3G mobile service, offered through the mobile operator core network 250, and mobile device 220 is capable to operate both in a macro cellular environment via a macro cell base station 260 and in a residential small scale network environment. Thus, HNB 210 is backward compatible with any existing mobile device 220.

Furthermore, in addition to base stations (e.g., base station 260, . . . ) in the macro cell access network, mobile device 220 can be served by a predetermined number of HNBs 210, namely HNBs 210 that reside within the user's residence 230, and cannot be in a soft handover state with the macro cell access network. Mobile device 220 can communicate either with macro cell base station 260 or HNBs 210, but not both simultaneously. As long as mobile device 220 is authorized to communicate with HNB 210, within the user's residence 230 it is desired that mobile device 220 communicate with associated HNBs 210.

HNBs 210 can employ the physical layer broadcast channel as described herein for femto cell base station identification. For instance, the Auxiliary Pilot Channel, the Secondary Common Pilot Channel, a femto pilot transmitted via a physical layer broadcast control channel, or the like can be leveraged by HNBs 210. Utilization of such approach enables mobile device 220 to significantly reduce battery power consumption, access attempts (and hence delay in acquiring a femto cell), and the like. Mobile device 220 can obtain a physical layer broadcast channel transmission from a particular HNB 210, and the transmission can be utilized by mobile device 220 to discover HNB 210. Based upon the received physical layer broadcast channel transmission, mobile device 220 can recognize that the particular HNB 210 is a femto cell base station (in contrast to received signals from base station 260, which can be used by mobile device 220 to recognize base station 260 as a macro cell base station). According to another illustration, mobile device 220 can identify an association type corresponding to the particular HNB 2 10. Moreover, mobile device 220 can distinguish the particular HNB 210 from a disparate HNB (e.g., another one of HNBs 210, disparate HNB(s) (not shown), . . . ). Hence, the physical layer broadcast channel can be utilized to uniquely identify the particular HNB 210. On the contrary, conventional approaches oftentimes leverage reading a Sync Channel and/or performing explicit registration attempts, which can result in more battery power consumption (e.g., due to more involved modem operation to read the Sync Channel, . . . ), access delay (e.g., due to message exchanges, number of access attempts, . . . ), and so forth.

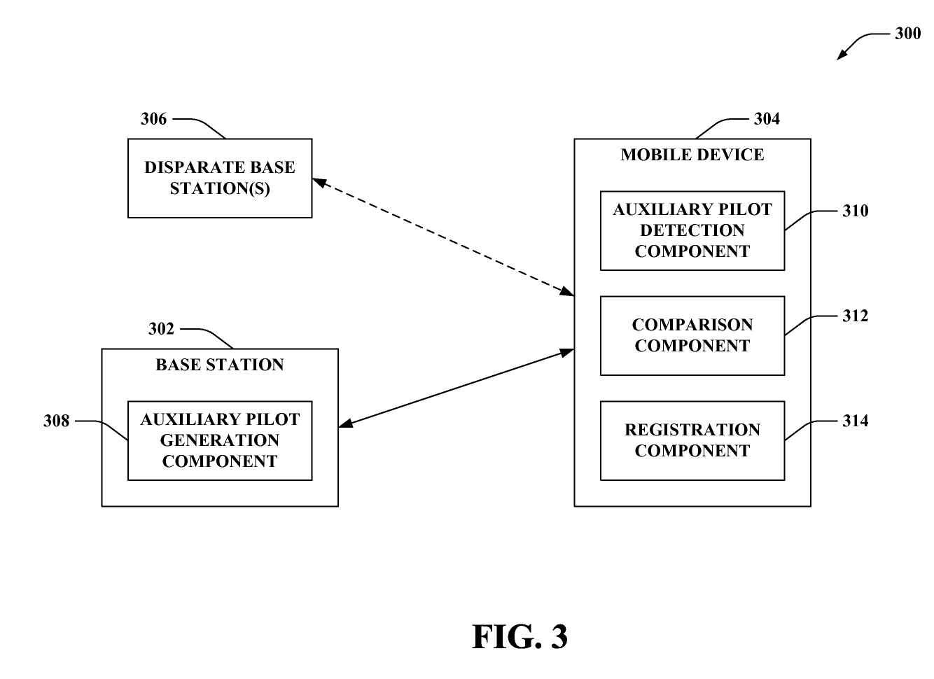

Referring to FIG. 3, illustrated is a system 300 that supports efficient femto cell system selection in a wireless communication environment. System 300 includes a base station 302 that can transmit and/or receive information, signals, data, instructions, commands, bits, symbols, and the like. Base station 302 can communicate with a mobile device 304 via the forward link and/or the reverse link. Mobile device 304 can transmit and/or receive information, signals, data, instructions, commands, bits, symbols, and the like. Further, system 300 can include any number of disparate base station(s) 306. It is to be appreciated that disparate base station(s) 306 can include any type of base station (e.g., one or more of disparate base station(s) 306 can be femto cell base stations, one or more of disparate base station(s) 306 can be macro cell base stations, . . . ). Moreover, although not shown, it is contemplated that any number of mobile devices similar to mobile device 304 can be included in system 300.

Base station 302 can further include an auxiliary pilot generation component 308 that can yield physical layer broadcast channel information that can indicate various characteristics associated with base station 302. Further, the physical layer broadcast channel information can be transmitted by base station 302 over the physical layer broadcast channel. By way of example, the physical layer broadcast channel information provided by auxiliary pilot generation component 308 can be received by mobile device 304. Further, mobile device 304 can distinguish one or more of the following characteristics based upon the obtained physical layer broadcast channel information. For instance, mobile device 304 can recognize whether base station 302 is a macro cell base station or a femto cell base station (or any disparate type of base station) as a function of the obtained physical layer broadcast channel information. Additionally or alternatively, mobile device 304 can uniquely identify base station 302 as being a specific femto cell base station, discernible from differing femto cell base station(s) (e.g., one or more of disparate base station(s) 306, . . . ), based upon the received physical layer broadcast channel information. According to another example, mobile device 304 can utilize the obtained physical layer broadcast channel information to recognize an association type of base station 302 (e.g. when base station 302 is identified to be a femto cell base station, . . . ). For instance, possible association types can include open, restricted, signaling, and the like.

Mobile device 304 can further include an auxiliary pilot detection component 310, a comparison component 312 and a registration component 314. Auxiliary pilot detection component 310 can scan the physical layer broadcast channel. Based upon the scan, auxiliary pilot detection component 310 can identify the physical layer broadcast channel information sent by base station 302 (e.g., via auxiliary pilot generation component 308, . . . ) and/or physical layer broadcast channel information sent by disparate base station(s) 306.

Further, comparison component 312 can evaluate the received physical layer broadcast channel information to recognize characteristics based thereupon. For instance, comparison component 312 can compare the received physical layer broadcast channel information to stored physical layer broadcast channel information (e.g., retained in memory (not shown), . . . ) to identify characteristics of a source base station (e.g., base station 302, disparate base station(s) 306, . . . ). By way of example, comparison component 312 can employ a whitelist of stored physical layer broadcast channel information corresponding to femto cell base stations accessible by mobile device 304, a blacklist of stored physical layer broadcast channel information corresponding to femto cell base stations that are non-accessible by mobile device 304, and so forth.

Further, registration component 314 can initiate registering mobile device 304 with a particular base station (e.g., base station 302, one of disparate base station(s) 306, . . . ) as a function of results yielded by comparison component 312. According to an example, when comparison component 312 recognizes that received physical layer broadcast channel information from the particular base station matches stored physical layer broadcast channel information corresponding to a femto cell base station accessible by mobile device 304 (e.g., from a whitelist, . . . ), registration component 314 can initiate reading a Sync Channel associated with the particular base station to check for a valid system identification/network identification (SID/NID). Moreover, if a valid SID/NID is identified, registration component 314 can proceed to register mobile device 304 with the particular base station.

Various examples described herein relate to the physical layer broadcast channel being an Auxiliary Pilot Channel included in the CDMA2000 air-interface. It is to be appreciated, however, that the claimed subject matter is not so limited. Rather, it is contemplated that the examples presented herein can be extended to the physical layer broadcast channel being a Secondary Common Pilot Channel, a femto pilot transmitted via a physical layer broadcast control channel, or the like.

The Auxiliary Pilot Channel conventionally was leveraged to support beam-forming and transmit diversity, yet as described herein, can be used for non-antenna applications. A set of distinct Auxiliary Pilot Walsh Codes can be utilized upon the Auxiliary Pilot Channel. Each Walsh Code is a unique code that can be assigned to modulate a pilot. Thus, an Auxiliary Pilot that has a unique look can be transmitted by a given base station (e.g., base station 302, disparate base station(s) 306, . . . ) based on the assigned Walsh Code (e.g., as yielded by auxiliary pilot generation component 308 for base station 302, . . . ). According to an illustration, the set can include 128 Walsh Codes (e.g., each of length 128, . . . ), 256 Walsh Codes (e.g., each of length 256, . . . ), 512 Walsh Codes (e.g., each of length 512, . . . ), and so forth; it is further contemplated that certain Walsh Codes can be unavailable for use for identification purposes as described herein. Moreover, a Fast Hadamard Transform can be utilized for decoding (e.g., by mobile device 304, . . . ). By way of illustration, if base station 302 is a femto cell base station, an Auxiliary Pilot modulated by an assigned Walsh Code can be transmitted in addition to a Common Pilot by base station 302 to help identify the femto cell (e.g., characteristics associated with base station 302, . . . ).

By way of example, femto cells and macro cells can utilize overlapping pseudo-noise (PN) offsets, where the PN offsets can be employed with a Common Pilot Channel. Since the space of femto and macro PN offsets can overlap completely in accordance with this example, mobile device 304 can be unable to recognize whether base station 302 (or any disparate base station(s) 306) is a macro cell base station or a femto cell base station by evaluating a Common Pilot received therefrom (e.g., because PN offset(s) assigned to femto cell base stations are non-distinct from PN offset(s) assigned to macro cell base stations, . . . ). Thus, the Auxiliary Pilot can be used to indicate that base station 302 (or any disparate base station(s) 306) is a femto cell base station (e.g., via a forward link (FL), . . . ). Hence, reservation of PN offsets for femto cell base stations can be avoided by using Auxiliary Pilots. Mobile device 304 can be femto-enabled, and can scan Auxiliary Pilots continuously (e.g. with auxiliary pilot detection component 310, . . . ). When comparison component 312 finds a femto Auxiliary Pilot (e.g., from base station 302, . . . ), registration component 314 can read the Sync Channel to check the SID/NID. The foregoing example can be implemented without reserving PN offsets for femto cell base stations and without changing PN management across a network. It is to be appreciated, however, that the claimed subject matter is not limited to this example.

According to a further illustration, certain Auxiliary Pilot Walsh Codes can be standardized (e.g., CDMA Development Group (CDG), . . . ) to indicate respective, corresponding association types, which can help when mobile devices are roaming. Thus, the Auxiliary Pilot can be used to indicate the association type corresponding to the femto cell. For instance, a first subset of Auxiliary Pilot Walsh Codes (e.g., a first Walsh Code, . . . ) can be reserved for open association, a second, non-overlapping subset of Auxiliary Pilot Walsh Codes (e.g., a differing, second Walsh Code, . . . ) can be reserved for signaling association, and a remaining valid set of Auxiliary Pilot Walsh Codes can indicate a restricted association. Signaling association, for instance, can enable a mobile device to access a femto cell base station for purposes of initiating a call or receiving a call/page from a network; subsequent to initiation, the mobile device hands over to a disparate base station (e.g., macro cell base station, femto cell base station with open association, femto cell base station with restricted association that is accessible by the mobile device, . . . ) for continuing the call. Moreover, it is contemplated that one or more Auxiliary Pilot Walsh Codes can be reserved for future usage. By employing the aforementioned scheme, mobile device 304 can refrain from unnecessary access attempts where the Sync Channel is read, evaluating paging, and then encountering registration failure (e.g., if a femto cell base station is assigned an Auxiliary Pilot Walsh Code from a large set, . . . ).

Pursuant to another example, system 300 can lack PN offsets reserved for femto cell base stations. Further, mobile device 304 can be located in a corresponding home operator region (e.g., not roaming, . . . ). Following this example, femto cell base stations can either be assigned to an open association Auxiliary Pilot or a restricted association Auxiliary Pilot. Moreover, strict whitelists can be employed by mobile devices (e.g., used by comparison component 312 of mobile device 304, . . . ). When mobile device 304 detects a new PN offset, auxiliary pilot detection component 310 can scan for femto Auxiliary Pilots. For instance, auxiliary pilot detection component 310 can recognize valid Auxiliary Pilots. A valid Auxiliary Pilot can be defined as having an energy per chip over thermal noise (Ec/No) that is sufficiently strong over a certain time window. Thereafter, for each valid Auxiliary Pilot, comparison component 312 can analyze a Walsh Code therefrom. By way of illustration, if comparison component 312 identifies that a Walsh Code from the valid Auxiliary Pilot matches a Walsh Code assigned to open association, then registration component 314 can initiate registration with a source femto cell base station from which the valid Auxiliary Pilot was received. If registration fails, then an error can be declared, and comparison component 312 can reevaluate the Walsh Code or analyze a disparate Walsh Code from a differing valid Auxiliary Pilot. In accordance with a further illustration, if comparison component 312 detects that a Walsh Code from the valid Auxiliary Pilot matches a Walsh Code allocated for restricted association and such Walsh Code is whitelisted (e.g., retained in memory, . . . ), then registration component 314 can begin registration with the source femto cell base station. Moreover, if such registration fails, then an error can be declared, and comparison component 312 can reanalyze the Walsh Code or review a disparate Walsh Code from a different valid Auxiliary Pilot. Alternatively, if comparison component 312 ascertains that a Walsh Code from the valid Auxiliary Pilot matches a Walsh Code allocated for restricted association, yet such Walsh Code is not whitelisted, then comparison component 312 can reevaluate the Walsh Code or analyze a disparate Walsh Code from a differing valid Auxiliary Pilot. Further, if all Auxiliary Pilots have been checked and registration was unsuccessful, then auxiliary pilot detection component 310 can again scan for valid Auxiliary Pilot(s). The claimed subject matter, yet, is not limited to the foregoing example.

Utilization of Auxiliary Pilots as described herein can provide various benefits. For instance, use of Auxiliary Pilots can reduce a number of Sync Channel reads; this can be valuable when a number of PN offsets reserved for femto cell usage is small (or no PN offsets are reserved for femto cell utilization) or when the number of restricted femto cell base stations is large. Moreover, techniques presented herein can reduce a number of access/registration failures if restricted femto cell base stations are assigned an Auxiliary Pilot from a large set of Walsh Codes; thus, access rate failures can generally decrease as a set of valid restricted association type Walsh Codes grows and are randomly assigned/selected. Further, battery power consumption of mobile devices can be reduced. Also, time to determine an invalid femto cell base station can be lowered, since fewer unnecessary Sync Channel SID/NID reads can be effectuated and/or less paging and access failures can result. This can be particularly valuable for off frequency searches (OFSs) for femto cell base stations, thereby yielding faster OFS search times. Additionally, chip timing and phase reference can be improved by leveraging the Auxiliary Pilots as described herein, which can be useful when two or more femto cell base stations are close in vicinity using a common PN offset.

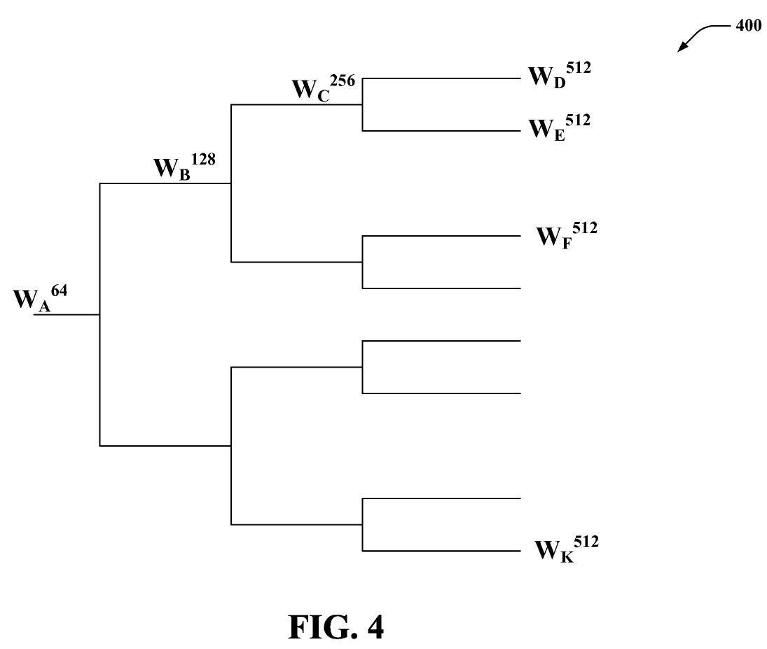

Turning to FIG. 4, illustrated is an example Walsh Code tree 400. Walsh Code tree 400 can relate to a Walsh Code space that includes 512 Walsh Codes, each of length 512. It is contemplated, however, that use of a Walsh Code space with any number of Walsh Codes, each with any length, is intended to fall within the scope of the heretoappended claims.

According to an illustration, the Walsh Code space (e.g., including length 512 Walsh Codes as shown, length 256 Walsh Codes (not depicted), . . . ) can be partitioned. Following this illustration, a set of the Walsh Codes can be reserved for femto cell base stations. Moreover, Walsh Codes in the set can possibly be assigned to indicate one of the following associations: open association, restricted association, signaling association, or a disparate association. However, it is contemplated that the claimed subject matter is not limited to the foregoing illustration.

A respective Walsh Code can be selected or assigned for use with an Auxiliary Pilot transmission by a corresponding femto cell base station. For instance, the Walsh Code can have a length of 256, 512, 1024, 2048, or the like. Moreover, a Walsh Code node (of length 64 or 128) can be removed based upon the respective Walsh Code selected or assigned to the corresponding femto cell base station. The removed node is connected to (above) the Auxiliary Pilot Walsh Code in Walsh Code tree 400. According to an illustration, if the femto cell base station has a mobile station modem (MSM) with forward link read capability, then the Auxiliary Pilot Walsh Code selection can be dynamic, thus mitigating overlap with neighboring femto cell base stations; yet, the claimed subject matter is not so limited.

The Walsh Code tree 400 can indicate blocked Walsh Codes. For instance, if a femto cell base station selects or is assigned to W_{F}⁵¹² (where F is an integer between 1 and 512) as a corresponding Auxiliary Pilot Walsh Code to be utilized for system identification and selection as described herein, then W_{A}⁶⁴ (where A is an integer between 1 and 64) cannot be used by that femto cell base station. As illustrated, W_{A}⁶⁴ is above W_{F}⁵¹² in Walsh Code tree 400. More particularly, W_{F}⁵¹² is a unique concatenation of 8 W_{A}⁶⁴ codes. For instance, W_{F}⁵¹²=[d₁W_{A}⁶⁴, d₂W_{A}⁶⁴, d₃W_{A}⁶⁴, . . . , d₈W_{A}⁶⁴].

To mitigate mistaking a neighboring femto or macro traffic channel as an Auxiliary Pilot, length 256 Walsh Codes or longer can be employed for the Auxiliary Pilot Channel (e.g., Walsh Codes of length 256, 512, 1024, 2048, . . . ). Walsh Codes typically used for other channels except for the Auxiliary Pilot Channel and the Auxiliary Transmit Diversity Pilot Channels oftentimes have a maximum length of 128. Accordingly, the Walsh Codes can be distinguishable by receiving mobile device(s).

Pursuant to another example, to avoid confusion in case macro cell base stations and femto cell base stations both use Auxiliary Pilots, the space of valid Auxiliary Pilot Walsh Codes can be partitioned. For instance, a first subset within the space of valid Auxiliary Pilot Walsh Codes can be allocated for femto cell usage, while a second subset within the space of valid Auxiliary Pilot Walsh Codes can be allotted for non-femto cell utilization. By way of illustration, the first subset and the second subset can be non-overlapping; yet, the claimed subject matter is not so limited.

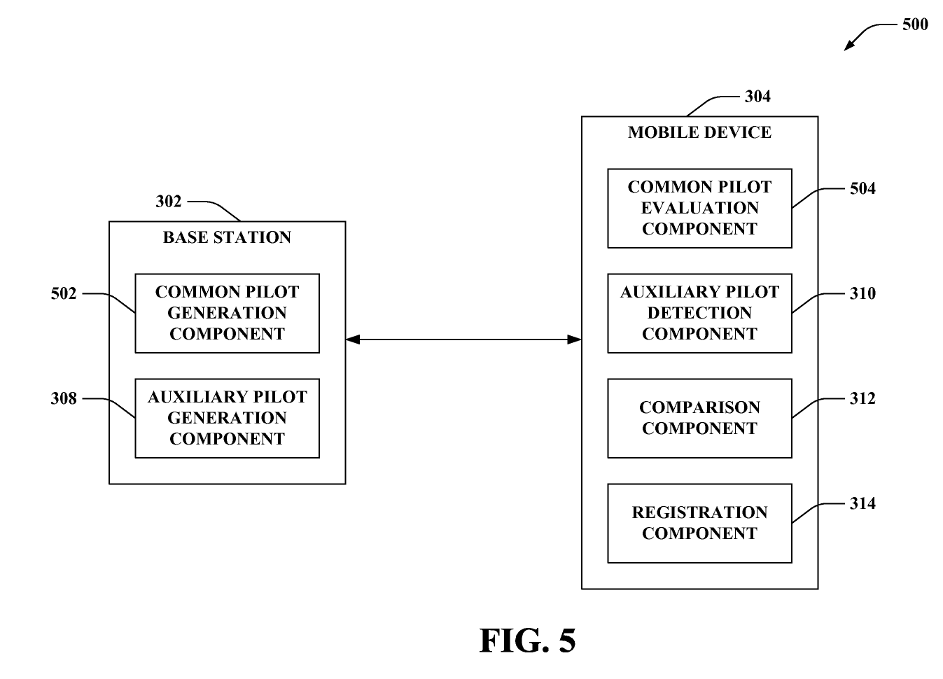

With reference to FIG. 5, illustrated is a system 500 that leverages Common Pilots and Auxiliary Pilots for femto cell system identification and selection in a wireless communication environment. System 500 includes base station 302 and mobile device 304. Although not shown, it is contemplated that system 500 can also include any number of disparate base stations (e.g., disparate base station(s) 306 of FIG. 3, . . . ) and/or any number of disparate mobile devices.

Base station 302 can include a common pilot generation component 502 and auxiliary pilot generation component 308. Common pilot generation component 502 can yield a pilot sequence (e.g., Common Pilot sequence, . . . ) with a particular PN offset. Depending upon network configuration, a set of potential PN offsets can include 256 PN offsets or 512 PN offsets; however, it is contemplated that use of any number of potential PN offsets is intended to fall within the scope of the heretoappended claims. The particular PN offset utilized by common pilot generation component 502 can enable base station 302 to be identified fairly uniquely in a particular geographic region, particularly if base station 302 is a macro cell base station. Moreover, a given PN offset from the set of potential PN offsets can similarly be utilized by common pilot generation component 502 if base station 302 is a femto cell base station.

A subset of the potential PN offsets can be reserved for femto cell usage. According to an illustration, 1 PN offset, 3 PN offsets, 6 PN offsets, or substantially any number of PN offsets from the set of potential PN offsets can be reserved for femto cell usage. Thus, if base station 302 is a femto cell base station, then common pilot generation component 502 can yield a pilot sequence with a given PN offset from the reserved subset of potential PN offsets employed for femto cells. The given PN offset, for instance, can be selected by common pilot generation component 502 (or base station 302 generally), assigned to base station 302, or the like. It is contemplated, however, that the claimed subject matter is not limited to use of reserved PN offset(s).

Mobile device 304 can further include a common pilot evaluation component 504, auxiliary pilot detection component 310, comparison component 312, and registration component 314. Common pilot evaluation component 504 can receive the pilot sequence yielded by common pilot generation component 502 of base station 302. Further, common pilot evaluation component 504 can identify a PN offset from the received pilot sequence. Common pilot evaluation component 504 can discern whether the identified PN offset is associated with a macro cell base station or a femto cell base station (e.g., analyze whether the identified PN offset matches a PN offset reserved for femto cell usage, . . . ). When common pilot evaluation component 504 finds a PN offset reserved for femto cell usage from a particular base station (e.g., base station 302, . . . ), auxiliary pilot detection component 310 can initiate Auxiliary Pilot scans (e.g., to recognize, evaluate, etc. a Walsh Code utilized by the particular base station for Auxiliary Pilot Channel transmission, . . . ). Further, upon detecting a desired (target) Auxiliary Pilot as recognized by comparison component 312, registration component 314 of mobile device 304 can read the Sync Channel to check the SID/NID.

The foregoing example, in comparison to the case where Auxiliary Pilots are absent, can reduce the number of unnecessary Sync Channel reads, which can lower access time and improve battery life of mobile device 304. Moreover, speed at which off frequency searches (OFSs) are effectuated can be increased in connection with system 500. Further, by evaluating information carried via Auxiliary Pilots, mobile device 304 can find finer information for multiple femto cell base stations in one shot. Conventional OFS techniques typically leverage looking for a strongest pilot and then reading the Sync Channel to obtain finer information associated with that pilot; in contrast, system 500 can support collecting finer information for a plurality of base stations via evaluating the Common Pilots and the Auxiliary Pilots. Also, for the co-channel scan case, mobile devices commonly can only read one Sync Channel at a given time.

The following provides an example scenario that depicts various aspects associated with system 500; it is to be appreciated, yet, that the claimed subject matter is not limited to this example. The following assumptions can be made as part of this example scenario. For instance, certain PN offsets can be reserved for femto cell base stations. Moreover, mobile device 304 can be in a home operator region (not roaming). Further, base station 302 can be a femto cell base station, and can be assigned an Auxiliary Pilot Walsh Code to be utilized for identification; for instance, base station 302 can be assigned one out of X length 512 Walsh Codes, where X can be an integer less than or equal to 512 (e.g., X can be 200, . . . ). Also, the example scenario can assume that the Walsh Code need not identify association type, and strict whitelists can be utilized in system 500. According to this scenario, common pilot evaluation component 504 can receive and analyze common pilots to identify a PN offset corresponding thereto. Upon common pilot evaluation component 504 finding a PN offset reserved for femto cell utilization, auxiliary pilot detection component 310 can search for femto Auxiliary Pilot(s) (e.g., one typically should be found when the PN offset reserved for femto cell utilization is identified, . . . ). For each found Auxiliary Pilot, comparison component 312 can compare a femto Auxiliary Pilot Walsh Code to Walsh Code(s) in a whitelist, and if a match is found, then registration component 312 can read the Sync Channel to check for a valid SID/NID. If the SID/NID is valid, then registration component 314 can proceed to register mobile device 304 (e.g., as effectuated in conventional techniques that typically fail to use Auxiliary Pilots to provide additional femto cell related information, . . . ). Moreover, if the SID/NID is invalid, then an error can be declared, mobile device 304 (e.g., comparison component 312, . . . ) can update a whitelist database, and comparison component 312 can reevaluate the found Auxiliary Pilot or analyze a disparate found Auxiliary Pilot. Further, if a femto Auxiliary Pilot Walsh Code is not in the whitelist as recognized by comparison component 312, then comparison component 312 can reanalyze the found Auxiliary Pilot or evaluate a disparate found Auxiliary Pilot. The foregoing can be repeated until all found Auxiliary Pilots have been processed; thereafter, mobile device 304 can again search for PN offset(s) reserved for femto cell base stations. It is to be appreciated, however, that the claimed subject matter is not limited to the aforementioned example scenario.

The Auxiliary Pilot (e.g., yielded by auxiliary pilot generation component 308, . . . ) can be used as an additional pilot to aid femto system detection or phase reference generation. Benefits can include providing a stronger, more reliable phase reference, which can be particularly useful when femto-to-femto interference is larger. For instance, when two or more femto cell base stations in close vicinity use the same PN offset, the Auxiliary Pilot can help generate a more reliable phase reference (assuming distinct Auxiliary Pilots are employed by each of these femto cell base stations). Conventionally, mobile devices use the Common Pilot for system acquisition and coherent detection of other channels; thus, with such common approaches, when two or more femto cell base stations use the same PN offset, mobile devices can interpret the Common Pilot as a single pilot, but with multipath. Further, in contrast, use of the Common Pilot and the Auxiliary Pilot can create a more accurate chip timing reference, which can improve detection of other channels (e.g., the Auxiliary Pilot, which can be un-modulated, can be cancelled, . . . ).

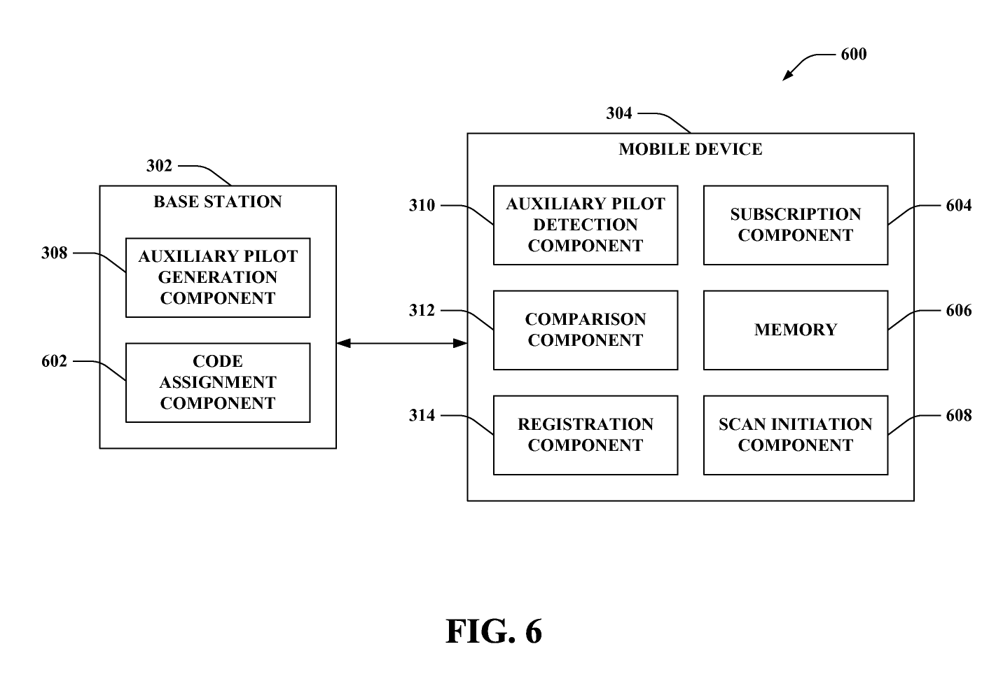

Now referring to FIG. 6, illustrated is a system 600 that employs Auxiliary Pilots to identify characteristics associated with femto cell base stations in a wireless communication environment. System 600 includes base station 302, which can further comprise auxiliary pilot generation component 308, and mobile device 304, which can further comprise auxiliary pilot detection component 310, comparison component 312, and registration component 314. Moreover, although not shown, it is contemplated that base station 302 can also include a common pilot generation component (e.g., common pilot generation component 502 of FIG. 5, . . . ) and/or mobile device 304 can additionally include a common pilot evaluation component (e.g., common pilot evaluation component 504 of FIG. 5, . . . ); however, the claimed subject matter is not so limited.

Base station 302 can further include a code assignment component 602 that selects or obtains an assigned Walsh Code from a set of Walsh Code for use by base station 302. Code assignment component 602, for instance, can receive user input that specifies the assigned Walsh Code. According to another illustration, the assigned Walsh Code can be programmed (e.g., via code assignment component 602, . . . ) by a vendor. By way of further example, code assignment component 602 can dynamically determine the assigned Walsh Code for base station 302. Following this example, code assignment component 602 can leverage a mobile system modem (MSM) to dynamically select a Walsh Code to be utilized by base station 302. Dynamic selection, for instance, can be based upon results returned from the MSM of base station 302 scanning and finding Auxiliary Pilots from disparate base stations (e.g., disparate femto cell base stations, . . . ). Thus, a Walsh Code other than Walsh Code(s) utilized by these disparate base stations can automatically and/or manually be selected via code assignment component 602 in response.

Mobile device 304 can also include a subscription component 604, memory 606, and a scan initiation component 608. Subscription component 604 can obtain information related to femto cell base station(s) that can be accessed by mobile device 304. For instance, subscription component 604 can collect Auxiliary Pilot Walsh Codes utilized by accessible femto cell base station(s) (e.g. base station 302, disparate femto cell base stations (not shown), . . . ). Thereafter, comparison component 312 can leverage the Auxiliary Pilot Walsh Codes identified by subscription component 604. Thus, the Walsh Codes that should be searched for by mobile device 304 can be known. Subscription component 604 can collect the Walsh Codes automatically and/or manually. For instance, the Walsh Codes can be provisioned by the network, entered by a user (e.g., provided to subscription component 304 via a user interface, automatically learned by mobile device 304, and so forth.

Further, the Walsh Codes obtained by subscription component 604 can be retained in memory 606. The Walsh Codes stored in memory 606 can be updated; thus, Walsh Codes can be added, removed, and so forth. For instance, a retained Walsh Code can be deleted from memory 606 if comparison component 312 finds that a received Auxiliary Pilot Walsh Code matches the retained Walsh Code from memory 606 and registration component 314 reads the Sync Channel and obtains an invalid SID/NID; however, the claimed subject matter is not so limited. It is to be appreciated that memory 606 can retain a whitelist of Walsh Codes for femto cell base station(s) accessible by mobile device 304, a blacklist of Walsh Codes for femto cell base station(s) that are non-accessible by mobile device 304, a combination thereof, and so forth. In accordance with an example, if a whitelist is employed, unlisted entries can implicitly be considered to be blacklisted; however, the claimed subject matter is not so limited.

Scan initiation component 608 can enable mobile device 304 to initiate scans for a femto cell base station. For instance, scan initiation component 608 can use off frequency search (OFS), a database for mobile-assisted discovery and selection (e.g., preferred user zone list (PUZL), . . . ), a combination thereof, and the like to cause scans to begin. By way of illustration, PUZL can be a database retained in memory 606 that assists mobile device 304 in recognizing when to start scanning for a desired femto cell base station (e.g. when a macro cell base station positioned nearby a subscriber's home is detected, . . . ). According to another illustration, OFS can be leveraged when attempting to locate a femto cell base station that previously has not been accessed by mobile device 304. According to an example, scan initiation component 608 can automatically start searching for a femto cell base station, begin scanning for a femto cell base station in response to an input (e.g., user input, . . . ), and so forth. Searches for femto cell base stations activated by scan initiation component 608 can involve scanning an Auxiliary Pilot Channel (e.g., with auxiliary pilot detection component 310, . . . ) rather than reading a Sync Channel (e.g., to obtain SID/NID information, . . . ). If the Auxiliary Pilot information (e.g. Walsh Code, . . . ) of the femto cell base station matches the locally stored Auxiliary Pilot information (e.g., retained Walsh Code stored in memory 606, . . . ), then registration component 314 can initiate the Sync Channel read.

Various other examples illustrate disparate aspects associated with the techniques described herein. Below are a few of these examples; yet, it is contemplated that the claimed subject matter is not limited to the following examples.

According to an example, mobile device 304 can need to identify a starting point of an Auxiliary Pilot Walsh Code (e.g., after detecting a Common Pilot with a particular PN offset with a common pilot evaluation component such as common pilot evaluation component 504 of FIG. 5, . . . ). Multiple Auxiliary Pilots can be sampled (e.g., multiple 512 chip integrations, . . . ) by auxiliary pilot detection component 310. The plurality of Auxiliary Pilots can be sampled to reduce a probability of false alarm (P_FA) and/or a probability of miss (P_Miss). False alarm can be permissible since under such a situation mobile device 304 can attempt to read the Sync Channel, thereby identifying that a returned SID/NID fails to provide a match. Thus, techniques can primarily attempt to mitigate misses, while simultaneously reducing false alarms.

The number of samples can be extended to avoid the following potential misidentification scenario. Consider a scenario where mobile device 304 scans a neighboring macro cell base station that uses a Walsh Code that is nearly identical to a target Auxiliary Pilot Walsh Code for which mobile device 304 is scanning. The Walsh Code used by the neighboring macro cell base station, for instance, can be higher in a Walsh Code tree (e.g., Walsh Code tree 400 of FIG. 4, . . . ); according to an illustration, such Walsh Code can be used by the neighboring macro cell base station for the forward link fundamental channel (F-FCH). Depending on a sequence of encoded bits modulating the length 64 Walsh Code (of the F-FCH), the cross-correlation with the target Auxiliary Pilot Walsh Code can range from [−1, 1].

To avoid the aforementioned scenario, auxiliary pilot detection component 310 (or mobile device 304 generally) can implement coherent detection. Further, auxiliary pilot detection component 310 can use multiple integration intervals when attempting to detect an Auxiliary Pilot Walsh Code. Multiple intervals can be leveraged since a signal other than the Auxiliary Pilot can be modulated and a likelihood of encoded bits of all 1's or all 0's decreases with integration interval length. Thus, to increase reliability of Auxiliary Pilot detection, a detection scheme can be employed in which multiple Auxiliary Pilot periods can be sampled (e.g., four consecutive 512 chip periods for a total of 2048 chips, . . . ). Further, base station 302 can allocate a larger transmit power ratio for the femto Auxiliary Pilot. Moreover, a power ratio of femto Auxiliary Pilot to Common Pilot can be predefined and known by mobile device (e.g., auxiliary pilot detection component 310, . . . ). Further, it is contemplated that a transmit power ratio of the Auxiliary Pilot to the Common Pilot sent by a base station can be determined. The transmit power ratio, for instance, can be adjusted to manage the P_FA to P_Miss rate at mobile device 304. Additionally or alternatively, a detected signal can be checked to identify peculiarities associated with other channels. For example, a F-FCH power level can change each 20 msec frame according to a voice frame rate. Further, F-FCH can have full-power transmit power control (TPC) bits punctured into the F-FCH bits.

Pursuant to another example, roaming can be supported in connection with the techniques described herein. For instance, if network operators utilize differing Auxiliary Walsh Code assignments for identifying differing association types, disparate partitions of the Walsh Code space between femto cell base stations and macro cell base stations (e.g., using beamforming, . . . ), or the like, then when a preferred roaming list (PRL) roaming indicator is on (e.g., a mobile device is roaming, . . . ), utilization of Auxiliary Pilot Walsh Codes for system selection can be disabled. According to another illustration, partitioning of the space for Auxiliary Pilots can be standardized (e.g., for femto versus macro versus beamforming applications, . . . ). It is to be appreciated, however, that the claimed subject matter is not so limited.

By way of another example, an Auxiliary Pilot Walsh Code used by a femto cell base station can be automatically learned by a mobile device. For instance, the mobile device can list Walsh Codes of length 512 that are received and a strongest Walsh Code can be selected and tested to confirm that it is from a correct femto Auxiliary Pilot; if incorrect, the mobile device can proceed to a next strongest Walsh Code of length 512, and so on. Moreover, the aforementioned can be refined by smartly searching via traversing from a top of a Walsh Code tree (e.g., looking for energy in length 4, then when found going to Walsh Codes of length 8, and so forth, . . . ).

According to a further example, techniques described herein using the Auxiliary Pilots can be in support of existing solutions (e.g., complementary to conventional techniques, . . . ). By way of another illustration, interference cancellation can be applied to both the Common Pilot and the Auxiliary Pilot (e.g., unmodulated, . . . ) in connection with the approaches described herein. Additionally or alternatively, it is also contemplated that multiple Auxiliary Pilots can be utilized at a femto cell base station; for instance, one Auxiliary Pilot can be employed to identify that the base station is a femto cell base station, and another Auxiliary Pilot can be utilized to indicate an association type or identity of the femto cell base station.

Pursuant to another example, an Auxiliary Pilot field can be added into PUZL, GNLM, service redirection messages, and the like. For instance, a field can be added to the PUZL database (e.g., in the whitelist, blacklist, . . . ) related to Auxiliary Pilot information; however, the claimed subject matter is not so limited.

By way of another example, a combination of two or more simultaneously transmitted Auxiliary Pilots can be used by each femto cell base station. For instance, if a combination of two Walsh Codes, each of length 512, is used by a given femto cell base station, then 512!/(2!*510!)=130,816 possible combinations can be provided. According to an illustration, a first Walsh Code can be used by the femto cell base station during a first time period, and a second Walsh Code can be used by the femto cell base station during a second time period, and so forth. Moreover, to avoid pilot collisions, a constraint can be added to define possible Auxiliary Pilot Walsh Code pairs (e.g., a pair can be set as [W_{Y}^{N}, W_{(Y+N/4)}^{N}], where W is a particular Walsh Code, N is a number of potential Walsh Codes in the Walsh Code space, and Y is an index, . . . ).

Although many of the examples described herein relate to use of Auxiliary Pilots, it is contemplated that a separate femto pilot can be utilized. For instance, the femto pilot can be transmitted via a physical layer broadcast control channel, which can be modulated to carry information (e.g., 8 bits, . . . ) indicating that a base station is a femto cell base station, association type, identity, and/or any disparate information. By way of illustration, transmissions can be sent via the channel using one of a number of possible modulation techniques (e.g., On-Off-Keying (OOK), . . . ), one of a number of different block codes (e.g., Hamming code for error detection and/or error correction, . . . ), and so forth.

Also, the claimed subject matter contemplates that larger length Walsh Codes can be utilized, particularly since femto cell base stations tend to be indoors and usually are employed to support typically stationary (or slow moving) mobile devices. Thus, Walsh Codes of lengths such as 1024, 2048, and so forth can be leveraged.

According to another example, network commands can be introduced in connection with various aspects described herein. For instance, network commands can be used with a femto cell base station to enable and/or disable an Auxiliary Pilot transmission, alter an Auxiliary Pilot Walsh Code selection mode, or provide reporting related to a particular Auxiliary Pilot Walsh Code used by a given femto cell base station. Moreover, network commands can be utilized with a mobile device to enable and/or disable Auxiliary Pilot detection and/or set, alter, etc. Auxiliary Pilot definitions for open association, signaling association, and so forth.

Moreover, techniques described herein can be extended to other standards such as, but not limited to DO, LTE, UMB, UMTS, WiMAX, and so forth. For instance, use of the Secondary Common Pilot Channel with any code of length 256 in addition to a Primary Common Pilot Channel (CPICH) in UMTS can be utilized. However, the claimed subject matter is not so limited.

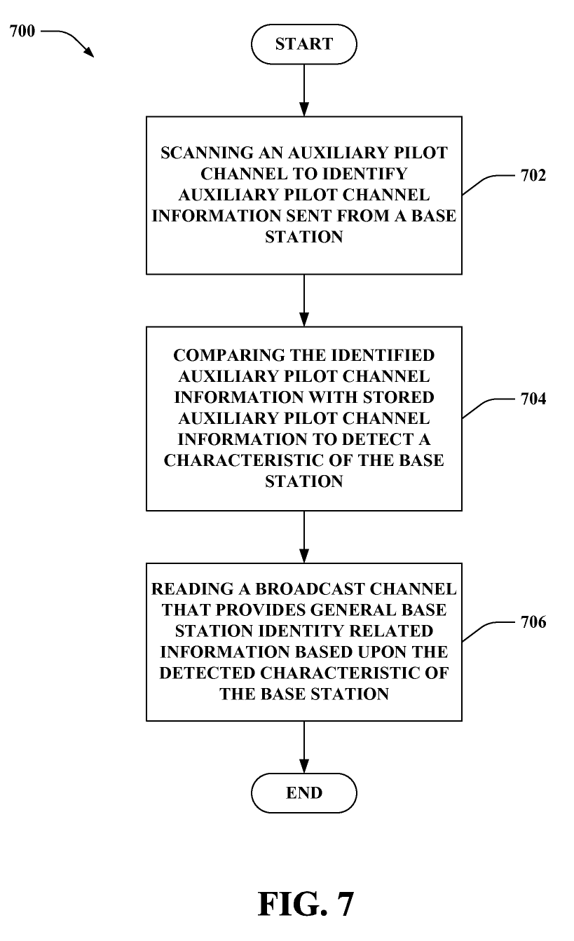

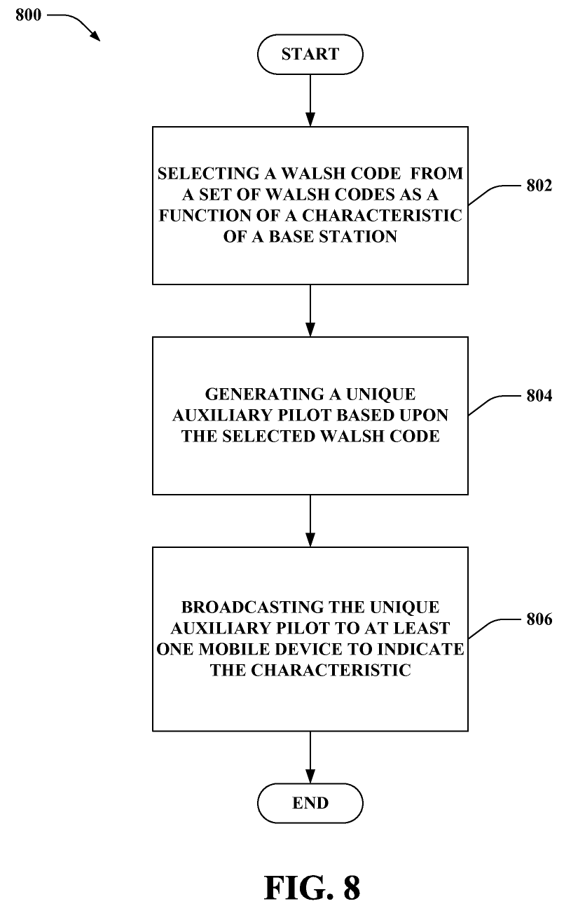

Referring to FIGS. 7-8, methodologies relating to femto cell system detection and selection are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 7, illustrated is a methodology 700 that facilitates detecting a femto cell base station in a wireless communication environment. At 702, an Auxiliary Pilot Channel can be scanned to identify auxiliary pilot channel information sent from a base station. By way of example, the base station can be a femto cell base station; however, it is contemplated that the base station can be a disparate type of base station. For instance, the identified auxiliary pilot channel information can include a particular, recognized Walsh Code from a set of possible Walsh Codes. Each Walsh Code in the set can have a length of 256, 512, 1024, 2048, or the like. By way of illustration, the set can include X possible Walsh Codes, each of length 512, where X can be an integer less than or equal to 512; however, that claimed subject matter is not so limited.

At 704, the identified auxiliary pilot channel information can be compared with stored auxiliary pilot channel information to detect a characteristic of the base station. The characteristic of the base station can be a base station type (e.g., femto cell base station, macro cell base station, . . . ), an association type of the base station (e.g. open association, restricted association, signaling association, . . . ), a unique identity corresponding to the base station (e.g. to distinguish the base station from other femto cell base station(s), . . . ), a combination thereof, and so forth. Moreover, the stored auxiliary pilot channel information can include one or more predefined Walsh Codes. For instance, the predefined Walsh Codes can be included in a whitelist, and thus, each of the predefined Walsh Codes corresponds to a respective, accessible femto cell base station (e.g., with restricted association, . . . ). By way of another illustration, the predefined Walsh Codes can be included in a blacklist, where each of the predefined Walsh Codes corresponds to a respective, non-accessible femto cell base station (e.g., with restricted association, . . . ). Additionally or alternatively, the predefined Walsh Codes can include a first reserved Walsh Code that indicates an open association and/or a second reserved Walsh Code that signifies a signaling association. Further, the identified auxiliary pilot channel information can be compared with the stored auxiliary pilot channel information by evaluating whether the particular, recognized Walsh Code matches one of the predefined Walsh Codes; the characteristic of the base station can be detected as a function of whether or not a match is identified. Moreover, the stored auxiliary pilot channel information (e.g., one or more predefined Walsh Codes, . . . ) can be provisioned by a network, obtained via user input, automatically learned, or the like.

At 706, a broadcast channel that provides general base station identity related information can be read based upon the detected characteristic of the base station. The broadcast channel that provides general base station identity related information, for instance, can be a Synchronization (Sync) Channel. For example, if the detected characteristic is that the base station employs open association, then the Sync Channel can be read. Further, if the detected characteristic is that the base station utilizes restricted association, then the Sync Channel can be read when the base station is recognized as being accessible (e.g., when the particular, recognized Walsh Code matches a predefined Walsh Code included in a whitelist or fails to match a predefined Walsh Code included in a blacklist, . . . ). The Sync Channel can be analyzed to check for a valid identifier (e.g., system identification/network identification (SID/NID), . . . ) corresponding to the base station. When the identifier is recognized as being valid, registration with the base station can be effectuated; otherwise, when the identifier is identified as being invalid, an error can be declared and the stored auxiliary pilot channel information can be updated.

According to another example, a Common Pilot Channel can be evaluated to search for a pseudo-noise (PN) offset reserved for femto cell base stations. It is contemplated that a set of PN offsets (e.g., the set can include 256 PN offsets, 512 PN offsets, . . . ) can be utilized in a wireless communication environment, and a subset of the PN offsets can be reserved for identifying femto cell base stations. For instance, the subset can include 1 reserved PN offset, 3 reserved PN offsets, 6 reserved PN offsets, or the like. Moreover, when a PN offset reserved for femto cell base stations is detected, scanning of the Auxiliary Pilot Channel can be initiated. Pursuant to a further example, a PN offset need not be reserved for femto cell base stations; following this example, the Auxiliary Pilot Channel can be scanned continuously. It is contemplated that the claimed subject matter is not limited to the foregoing examples.

By way of further example, scanning of the Auxiliary Pilot Channel can be commenced based upon location related information retained in a database for mobile-assisted discovery and selection (e.g., a preferred user zone list (PUZL) database, . . . ). In accordance with another example, scanning of the Auxiliary Pilot Channel can be started in response to an off frequency search (OFS). For instance, the OFS can be initiated automatically and/or manually to find a femto cell base station previously not accessed by a given mobile device. It is to be appreciated, however, that the claimed subject matter is not limited to the aforementioned examples.

Now referring to FIG. 8, illustrated is a methodology 800 that facilitates disseminating femto cell base station related information to one or more mobile devices in a wireless communication environment. At 802, a Walsh Code from a set of Walsh Codes can be selected as a function of a characteristic of a base station. For instance, the base station can be a femto cell base station. Moreover, each Walsh Code in the set can have a length of 256, 512, 1024, 2048, or the like. By way of illustration, the set can include X possible Walsh Codes, each of length 512, where X can be an integer less than or equal to 512; however, that claimed subject matter is not so limited. The characteristic of the base station can be a base station type (e.g., femto cell base station, macro cell base station, . . . ), an association type of the base station (e.g., open association, restricted association, signaling association, . . . ), a unique identity corresponding to the base station (e.g. to distinguish the base station from other femto cell base station(s), . . . ), a combination thereof, and so forth. According to an example, a first reserved Walsh Code from the set can be selected to indicate that open association is leveraged by the base station and/or a second reserved Walsh Code from the set can be selected to indicate that signaling association is utilized by the base station. Pursuant to a further illustration, the Walsh Code from the set of Walsh Codes can be assigned to the base station (e.g., programmed by a user, set by a vendor, dynamically determined, . . . ). At 804, a unique Auxiliary Pilot can be generated based upon the selected Walsh Code. At 806, the unique Auxiliary Pilot can be broadcasted to at least one mobile device to indicate the characteristic. The at least one mobile device can utilize the indicated characteristic for system detection and selection.

According to another example, a pseudo-noise (PN) offset reserved for femto cell base stations can be selected. It is contemplated that a set of PN offsets (e.g., the set can include 256 PN offsets, 512 PN offsets, . . . ) can be utilized in a wireless communication environment, and a subset of the PN offsets can be reserved for identifying femto cell base stations. For example, the subset can include 1 reserved PN offset, 3 reserved PN offsets, 6 reserved PN offsets, or the like. Further, a Common Pilot that incorporates the selected, reserved PN offset can be transmitted to the at least one mobile device; inclusion of the selected, reserved PN offset can signify that the base station is a femto cell base station. By way of a further illustration, PN offset(s) reserved for femto cell base stations need not be leveraged within a wireless communication environment.

It will be appreciated that, in accordance with one or more aspects described herein, inferences can be made regarding using a broadcast control channel to transfer information for identifying and/or selecting a base station in a wireless communication environment. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

According to an example, one or more methods presented above can include making inferences pertaining to determining a particular Walsh Code from a set of potential Walsh Codes to be employed by a femto cell base station based upon Walsh Code(s) identified as being utilized by neighboring femto cell base station(s). By way of further illustration, an inference can be made related to automatically determining a Walsh Code utilized by a particular femto cell base station. It will be appreciated that the foregoing examples are illustrative in nature and are not intended to limit the number of inferences that can be made or the manner in which such inferences are made in conjunction with the various embodiments and/or methods described herein.

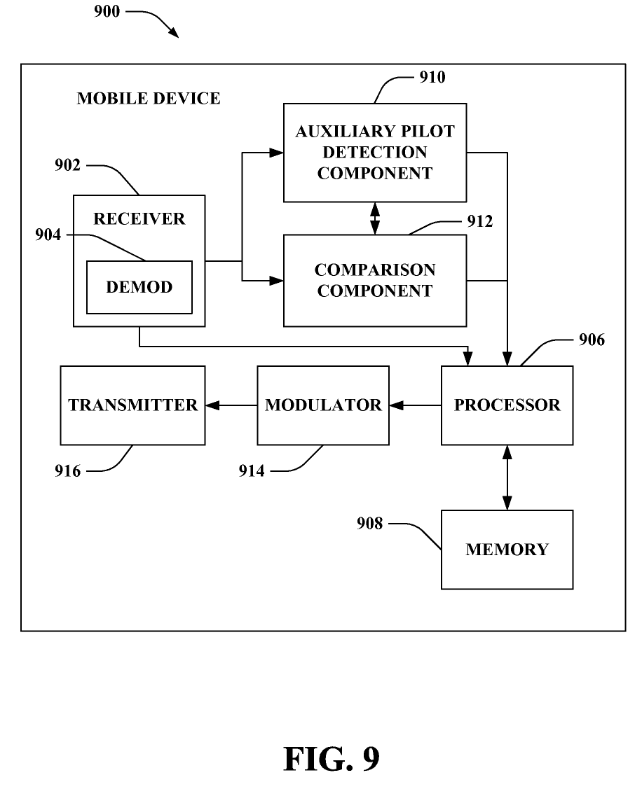

FIG. 9 is an illustration of a mobile device 900 that evaluates an Auxiliary Pilot Channel to recognize characteristics of a base station in a wireless communication system. Mobile device 900 comprises a receiver 902 that receives a signal from, for instance, a receive antenna (not shown), and performs typical actions thereon (e.g., filters, amplifies, downconverts, etc.) the received signal and digitizes the conditioned signal to obtain samples. Receiver 902 can be, for example, an MMSE receiver, and can comprise a demodulator 904 that can demodulate received symbols and provide them to a processor 906 for channel estimation. Processor 906 can be a processor dedicated to analyzing information received by receiver 902 and/or generating information for transmission by a transmitter 916, a processor that controls one or more components of mobile device 900, and/or a processor that both analyzes information received by receiver 902, generates information for transmission by transmitter 916, and controls one or more components of mobile device 900.

Mobile device 900 can additionally comprise memory 908 (e.g., memory 606 of FIG. 6, . . . ) that is operatively coupled to processor 906 and that can store data to be transmitted, received data, and any other suitable information related to performing the various actions and functions set forth herein. Memory 908, for instance, can store protocols and/or algorithms associated with evaluating an Auxiliary Pilot Channel, comparing received auxiliary pilot channel information to stored auxiliary pilot channel information, and so forth. Further, memory 908 can store auxiliary pilot channel information (e.g., Walsh Code(s), whitelist, blacklist, . . . ), a database for mobile-assisted discovery and selection (e.g., a PUZL database, . . . ), and so forth.

It will be appreciated that the data store (e.g., memory 908) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 908 of the subject systems and methods is intended to comprise, without being limited to, these and any other suitable types of memory.

Processor 906 can be operatively coupled to an auxiliary pilot detection component 910 and/or a comparison component 912. Auxiliary pilot detection component 910 can be substantially similar to auxiliary pilot detection component 310 of FIG. 3 and/or comparison component 912 can be substantially similar to comparison component 312 of FIG. 3. Auxiliary pilot detection component 910 can scan an Auxiliary Pilot Channel to obtain auxiliary pilot channel information (e.g., Walsh Code(s), . . . ). Moreover, comparison component 912 can analyze the obtained auxiliary pilot channel information. For instance, comparison component 312 can compare the obtained auxiliary pilot channel information with stored auxiliary pilot channel information retained in memory 908 to identify characteristic(s) of broadcasting base station(s). Although not shown, it is contemplated that mobile device 900 can further include a registration component (e.g., substantially similar to registration component 314 of FIG. 3, . . . ), a common pilot evaluation component (e.g., substantially similar to common pilot evaluation component 504 of FIG. 5, . . . ), a subscription component (e.g., substantially similar to subscription component 604 of FIG. 6, . . . ) and/or a scan initiation component (e.g., substantially similar to scan initiation component 608 of FIG. 6, . . . ). Mobile device 900 still further comprises a modulator 914 and a transmitter 916 that transmits data, signals, etc. to a base station. Although depicted as being separate from the processor 906, it is to be appreciated that auxiliary pilot detection component 910, comparison component 912 and/or modulator 914 can be part of processor 906 or a number of processors (not shown).

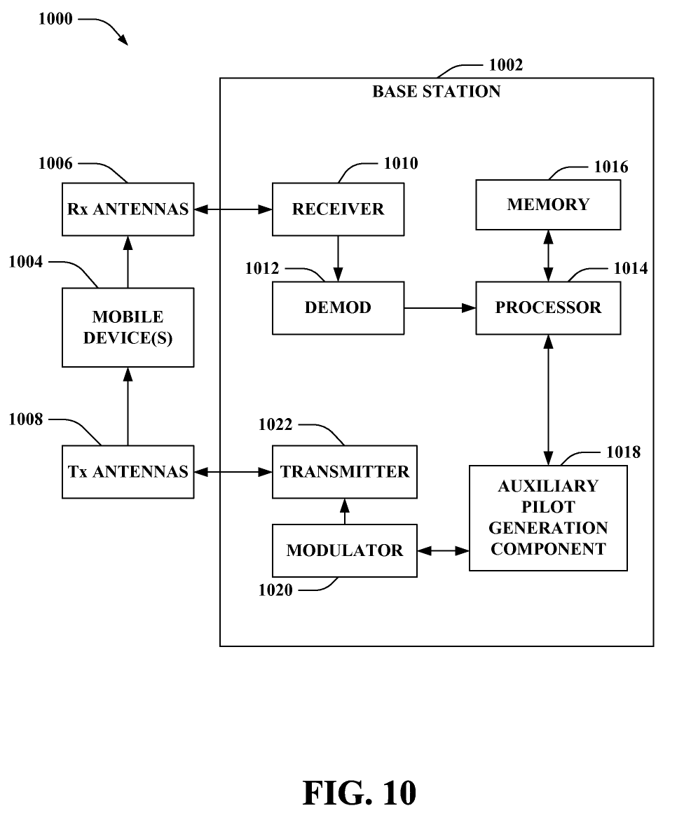

FIG. 10 is an illustration of a system 1000 that provides information utilized for system identification and/or detection in a wireless communication environment. System 1000 comprises a base station 1002 (e.g., access point, . . . ) with a receiver 1010 that receives signal(s) from one or more mobile devices 1004 through a plurality of receive antennas 1006, and a transmitter 1022 that transmits to the one or more mobile devices 1004 through a transmit antenna 1008. Receiver 1010 can receive information from receive antennas 1006 and is operatively associated with a demodulator 1012 that demodulates received information. Demodulated symbols are analyzed by a processor 1014 that can be similar to the processor described above with regard to FIG. 9, and which is coupled to a memory 1016 that stores data to be transmitted to or received from mobile device(s) 1004 and/or any other suitable information related to performing the various actions and functions set forth herein. Processor 1014 is further coupled to an auxiliary pilot generation component 1018 that yields unique Auxiliary Pilot(s) as a function of a selected/assigned Walsh Code as described herein. It is contemplated that auxiliary pilot generation component 1018 can be substantially similar to auxiliary pilot generation component 302 of FIG. 3. Moreover, although not shown, it is to be appreciated that base station 1002 can further include an common pilot generation component (e.g., substantially similar to common pilot generation component 502 of FIG. 5, . . . ) and/or a code assignment component (e.g., substantially similar to code assignment component 602 of FIG. 6, . . . ). Base station 1002 can further include a modulator 1020. Modulator 1020 can multiplex a frame for transmission by a transmitter 1022 through antennas 1008 to mobile device(s) 1004 in accordance with the aforementioned description. Although depicted as being separate from the processor 1014, it is to be appreciated that auxiliary pilot generation component 1018 and/or modulator 1020 can be part of processor 1014 or a number of processors (not shown).

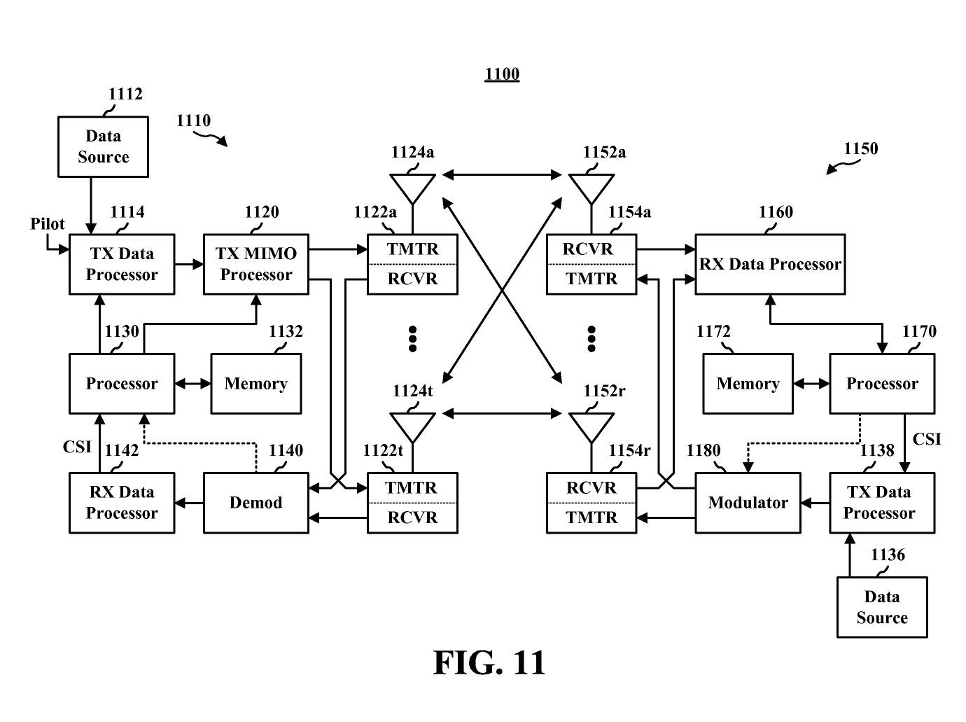

FIG. 11 shows an example wireless communication system 1100. The wireless communication system 1100 depicts one base station 1110 and one mobile device 1150 for sake of brevity. However, it is to be appreciated that system 1100 can include more than one base station and/or more than one mobile device, wherein additional base stations and/or mobile devices can be substantially similar or different from example base station 1110 and mobile device 1150 described below. In addition, it is to be appreciated that base station 1110 and/or mobile device 1150 can employ the systems (FIGS. 1-3, 5-6, 9-10 and 12-13) and/or methods (FIGS. 7-8) described herein to facilitate wireless communication there between.

At base station 1110, traffic data for a number of data streams is provided from a data source 1112 to a transmit (TX) data processor 1114. According to an example, each data stream can be transmitted over a respective antenna. TX data processor 1114 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1150 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1130.

The modulation symbols for the data streams can be provided to a TX MIMO processor 1120, which can further process the modulation symbols (e.g., for OFDM). TX MIMO processor 1120 then provides N_{T} modulation symbol streams to N_{T} transmitters (TMTR) 1122a through 1122t. In various embodiments, TX MIMO processor 1120 applies beamforming weights to the symbols of the data streams and to the antenna from which the symbol is being transmitted.

Each transmitter 1122 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1122a through 1122t are transmitted from N_{T} antennas 1124a through 1124t, respectively.

At mobile device 1150, the transmitted modulated signals are received by N_{R} antennas 1152a through 1152r and the received signal from each antenna 1152 is provided to a respective receiver (RCVR) 1154a through 1154r. Each receiver 1154 conditions (e.g., filters, amplifies, and downconverts) a respective signal, digitizes the conditioned signal to provide samples, and further processes the samples to provide a corresponding “received” symbol stream.

An RX data processor 1160 can receive and process the N_{R} received symbol streams from N_{R} receivers 1154 based on a particular receiver processing technique to provide N_{T} “detected” symbol streams. RX data processor 1160 can demodulate, deinterleave, and decode each detected symbol stream to recover the traffic data for the data stream. The processing by RX data processor 1160 is complementary to that performed by TX MIMO processor 1120 and TX data processor 1114 at base station 1110.

A processor 1170 can periodically determine which preceding matrix to utilize as discussed above. Further, processor 1170 can formulate a reverse link message comprising a matrix index portion and a rank value portion.

The reverse link message can comprise various types of information regarding the communication link and/or the received data stream. The reverse link message can be processed by a TX data processor 1138, which also receives traffic data for a number of data streams from a data source 1136, modulated by a modulator 1180, conditioned by transmitters 1154a through 1154r, and transmitted back to base station 1110.

At base station 1110, the modulated signals from mobile device 1150 are received by antennas 1124, conditioned by receivers 1122, demodulated by a demodulator 1140, and processed by a RX data processor 1142 to extract the reverse link message transmitted by mobile device 1150. Further, processor 1130 can process the extracted message to determine which preceding matrix to use for determining the beamforming weights.

Processors 1130 and 1170 can direct (e.g., control, coordinate, manage, etc.) operation at base station 1110 and mobile device 1150, respectively. Respective processors 1130 and 1170 can be associated with memory 1132 and 1172 that store program codes and data. Processors 1130 and 1170 can also perform computations to derive frequency and impulse response estimates for the uplink and downlink, respectively.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

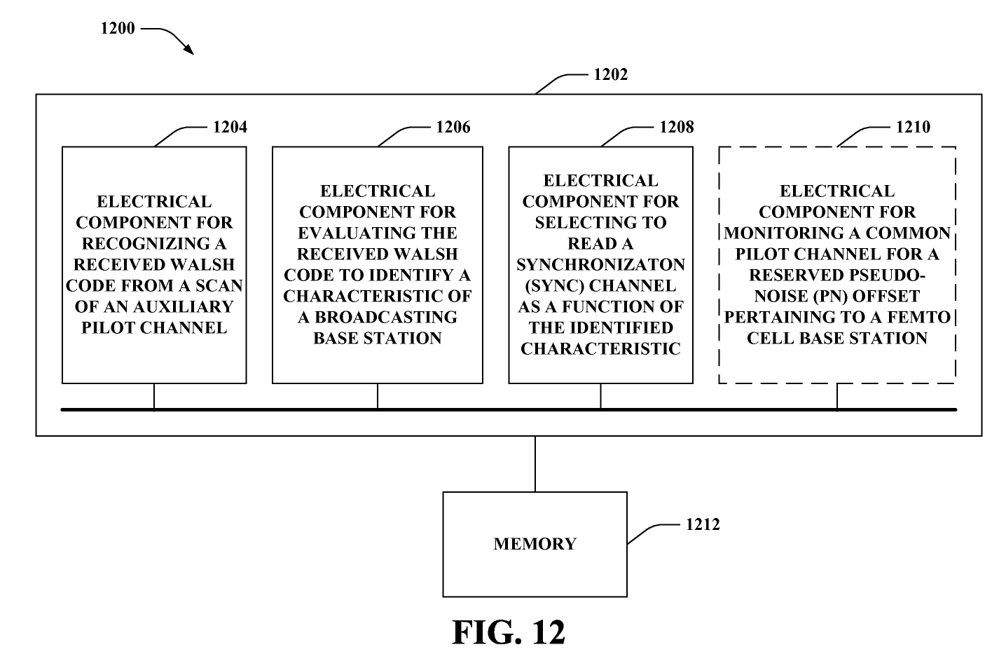

With reference to FIG. 12, illustrated is a system 1200 that enables detecting a femto cell base station in a wireless communication environment. For example, system 1200 can reside within a mobile device. It is to be appreciated that system 1200 is represented as including functional blocks, which can be functional blocks that represent functions implemented by a processor, software, or combination thereof (e.g., firmware). System 1200 includes a logical grouping 1202 of electrical components that can act in conjunction. For instance, logical grouping 1202 can include an electrical component for recognizing a received Walsh Code from a scan of an Auxiliary Pilot Channel 1204. Further, logical grouping 1202 can include an electrical component for evaluating the received Walsh Code to identify a characteristic of a broadcasting base station 1206. Moreover, logical grouping 1202 can comprise an electrical component for selecting to read a Synchronization (Sync) Channel as a function of the identified characteristic 1208. Logical grouping 1202 can also optionally include an electrical component for monitoring a Common Pilot Channel for a reserved pseudo-noise (PN) offset pertaining to a femto cell base station 1210. Additionally, system 1200 can include a memory 1212 that retains instructions for executing functions associated with electrical components 1204, 1206, 1208, and 1210. While shown as being external to memory 1212, it is to be understood that one or more of electrical components 1204, 1206, 1208, and 1210 can exist within memory 1212.

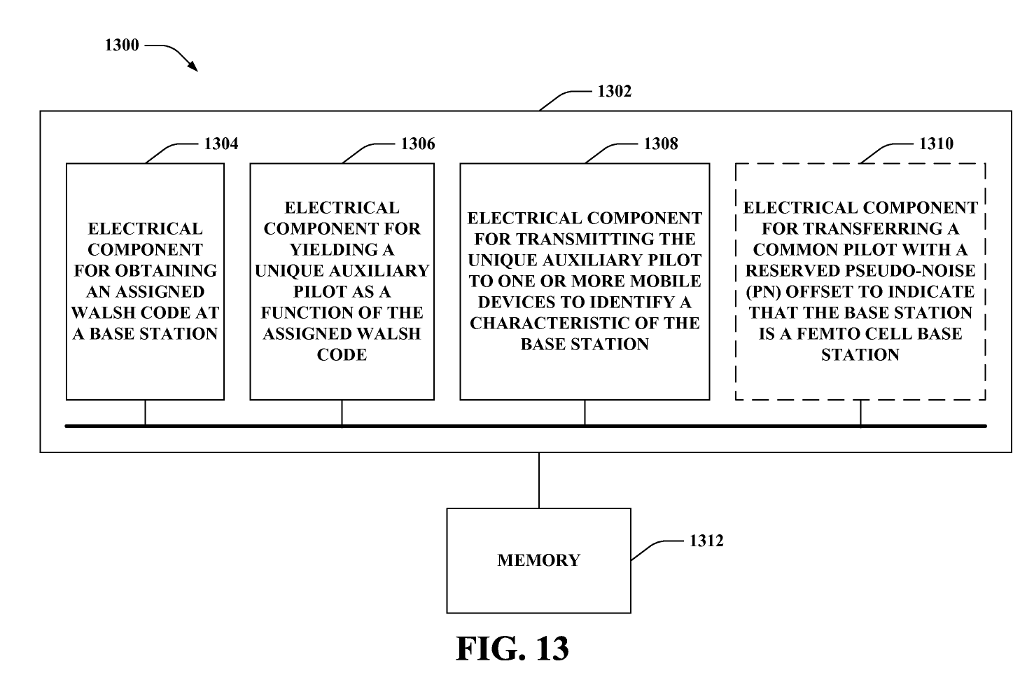

With reference to FIG. 13, illustrated is a system 1300 that enables broadcasting identification information used for system selection in a wireless communication environment. For example, system 1300 can reside at least partially within a base station. It is to be appreciated that system 1300 is represented as including functional blocks, which can be functional blocks that represent functions implemented by a processor, software, or combination thereof (e.g., firmware). System 1300 includes a logical grouping 1302 of electrical components that can act in conjunction. For instance, logical grouping 1302 can include an electrical component for obtaining an assigned Walsh Code at a base station 1304. Moreover, logical grouping 1302 can include an electrical component for yielding a unique Auxiliary Pilot as a function of the assigned Walsh Code 1306. Further, logical grouping 1302 can include an electrical component for transmitting the unique Auxiliary Pilot to one or more mobile devices to identify a characteristic of the base station 1308. Logical grouping 1302, in addition, can optionally include an electrical component for transferring a Common Pilot with a reserved pseudo-noise (PN) offset to indicate that the base station is a femto cell base station 1310. Additionally, system 1300 can include a memory 1312 that retains instructions for executing functions associated with electrical components 1304, 1306, 1308, and 1310. While shown as being external to memory 1312, it is to be understood that one or more of electrical components 1304, 1306, 1308, and 1310 can exist within memory 1312.

The various illustrative logics, logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g. a combination of a DSP and a microprocessor, a plurality of microprocessors, one or more microprocessors in conjunction with a DSP core, or any other such configuration. Additionally, at least one processor can comprise one or more modules operable to perform one or more of the steps and/or actions described above.

Further, the steps and/or actions of a method or algorithm described in connection with the aspects disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some aspects, the processor and the storage medium can reside in an ASIC. Additionally, the ASIC can reside in a user terminal. In the alternative, the processor and the storage medium can reside as discrete components in a user terminal. Additionally, in some aspects, the steps and/or actions of a method or algorithm can reside as one or any combination or set of codes and/or instructions on a machine readable medium and/or computer readable medium, which can be incorporated into a computer program product.

In one or more aspects, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments can be described or claimed in the singular, the plural is contemplated unless limitation to the singular is explicitly stated. Additionally, all or a portion of any aspect and/or embodiment can be utilized with all or a portion of any other aspect and/or embodiment, unless stated otherwise.

What is claimed is:

1. A method, comprising:
scanning an Auxiliary Pilot Channel to identify auxiliary pilot channel information sent from a base station;
comparing the identified auxiliary pilot channel information with stored auxiliary pilot channel information to detect a characteristic of the base station; and
reading a broadcast channel that provides general base station identity related information based upon the detected characteristic of the base station.

2. The method of claim 1, further comprising:
evaluating a Common Pilot Channel to search for at least one pseudo-noise (PN) offset reserved for femto cell base stations; and
initiating the scan of the Auxiliary Pilot Channel upon detecting one of the at least one PN offset reserved for femto cell base stations.

3. The method of claim 1, further comprising continuously scanning the Auxiliary Pilot Channel.

4. The method of claim 1, further comprising commencing the scan of the Auxiliary Pilot Channel based upon at least one of location information retained in a database for mobile-assisted discovery and selection or initiation of an off frequency search (OFS).

5. The method of claim 1, wherein the characteristic of the base station is at least one of a base station type, an association type of the base station, or a unique identity corresponding to the base station.

6. The method of claim 1, wherein the identified auxiliary pilot channel information comprises a particular, recognized Walsh Code from a set of possible Walsh Codes and the stored auxiliary pilot channel information comprises one or more predefined Walsh Codes.

7. The method of claim 6, wherein the predefined Walsh Codes are included in a whitelist, and each of the predefined Walsh Codes corresponds to a respective, accessible femto cell base station.

8. The method of claim 6, wherein the predefined Walsh Codes are included in a blacklist, and each of the predefined Walsh Codes corresponds to a respective, non-accessible femto cell base station.

9. The method of claim 6, wherein the predefined Walsh Codes comprise at least one of a first reserved Walsh Code that indicates an open association or a second reserved Walsh Code that signifies a signaling association.

10. The method of claim 6, comparing the identified auxiliary pilot channel information with the stored auxiliary pilot channel information further comprises evaluating whether the particular, recognized Walsh Code matches one of the predefined Walsh Codes.

11. The method of claim 1, wherein the broadcast channel that provides general base station identity related information is a Synchronization (Sync) Channel.

12. The method of claim 11, further comprising reading the Sync Channel upon detecting that the base station employs open association.

13. The method of claim 11, further comprising reading the Sync Channel upon detecting that the base station utilizes restricted association and is accessible.

14. The method of claim 11, further comprising updating the stored auxiliary pilot channel information upon recognizing an invalid identifier corresponding to the base station from the Sync Channel read.

15. A wireless communications apparatus, comprising:
at least one processor configured to:
collect information sent by a base station via a physical layer broadcast channel; and
detect at least one of a type of the base station, an association type supported by the base station, or a unique identity that distinguishes the base station from disparate base stations as a function of the collected information obtained via the physical layer broadcast channel.

16. The wireless communications apparatus of claim 15, wherein the physical layer broadcast channel is one of an Auxiliary Pilot Channel, a Universal Mobile Telecommunication System (UMTS) Secondary Common Pilot Channel, or a femto pilot transmitted via a physical layer broadcast control channel.

17. The wireless communications apparatus of claim 15, further comprising:
at least one processor configured to:
read a Synchronization (Sync) Channel based upon the detection of at least one of the type of the base station, the association type supported by the base station, or the unique identity.

18. The wireless communications apparatus of claim 15, further comprising:
at least one processor configured to:
search a Common Pilot Channel for at least one pseudo-noise (PN) offset reserved for femto cell base stations; and
initiate a scan of the physical layer broadcast channel to collect the information upon detecting one of the at least one PN offset reserved for femto cell base stations.

19. The wireless communications apparatus of claim 15, further comprising:
at least one processor configured to:
constantly scan the physical layer broadcast channel for the information sent by the base station.

20. The wireless communications apparatus of claim 15, further comprising:
at least one processor configured to:
compare the collected information sent by the base station with stored information, wherein the collected information includes a particular Walsh Code assigned to the base station and the stored information includes one or more predefined Walsh Codes retained in memory.

21. An apparatus, comprising:
means for recognizing a received Walsh Code from a scan of an Auxiliary Pilot Channel;
means for evaluating the received Walsh Code to identify a characteristic of a broadcasting base station; and
means for selecting to read a Synchronization (Sync) Channel as a function of the identified characteristic.

22. The apparatus of claim 21, further comprising means for monitoring a Common Pilot Channel for a reserved pseudo-noise (PN) offset pertaining to a femto cell base station.

23. The apparatus of claim 22, wherein the scan of the Auxiliary Pilot Channel begins upon detection of the reserved PN offset.

24. The apparatus of claim 21, wherein the scan of the Auxiliary Pilot Channel is continuous.

25. The apparatus of claim 21, wherein the scan of the Auxiliary Pilot Channel is commenced based upon at least one of location information retained in a database for mobile-assisted discovery and selection or initiation of an off frequency search (OFS).

26. The apparatus of claim 21, wherein the characteristic of the base station is at least one of a base station type, an association type of the base station, or a unique identity corresponding to the base station.

27. The apparatus of claim 21, wherein the received Walsh Code is recognized over multiple consecutive Auxiliary Pilot periods.

28. The apparatus of claim 21, wherein a given Walsh Code used by a particular femto cell base station is automatically learned, and the given Walsh Code is compared with the received Walsh Code to identify whether the broadcasting base station is the particular femto cell base station.

29. The apparatus of claim 21, wherein the received Walsh Code is compared with at least one of a first reserved Walsh Code that indicates an open association or a second reserved Walsh Code that signifies a signaling association.

30. A computer program product, comprising:
a computer-readable medium comprising:
code for causing at least one computer to analyze an Auxiliary Pilot Channel to identify auxiliary pilot channel information sent from a base station;
code for causing at least one computer to compare the identified auxiliary pilot channel information with stored auxiliary pilot channel information to detect a characteristic of the base station; and
code for causing at least one computer to read a broadcast channel that provides general base station identity related information based upon the detected characteristic of the base station.

31. The computer program product of claim 30, wherein the computer-readable medium further comprises:
code for causing at least one computer to search for at least one pseudo-noise (PN) offset reserved for femto cell base stations upon a Common Pilot Channel; and
code for causing at least one computer to commence analyzing the Auxiliary Pilot Channel upon identifying one of the at least one PN offset reserved for femto cell base stations.

32. The computer program product of claim 30, wherein the characteristic of the base station is at least one of a base station type, an association type of the base station, or a unique identity corresponding to the base station.

33. An apparatus, comprising:
an auxiliary pilot detection component that scans a physical layer broadcast channel to identify physical layer broadcast channel information sent by a base station;
a comparison component that evaluates the received physical layer broadcast channel information to recognize at least one characteristic of the base station by comparing the received physical layer broadcast channel information to stored physical layer broadcast channel information; and
a registration component that initiates registration with the base station as a function of the at least one characteristic.

34. The apparatus of claim 33, further comprising a common pilot evaluation component that identifies a pseudo-noise (PN) offset from a received pilot sequence and recognizes whether the identified PN offset is a reserved PN offset used for femto cell indication.

35. A method, comprising:
selecting a Walsh Code from a set of Walsh Codes as a function of a characteristic of a base station;
generating a unique Auxiliary Pilot based upon the selected Walsh Code; and
broadcasting the unique Auxiliary Pilot to at least one mobile device to indicate the characteristic.

36. The method of claim 35, wherein the characteristic of the base station is at least one of a base station type, an association type of the base station, or a unique identity corresponding to the base station.

37. The method of claim 35, further comprising:
selecting a first reserved Walsh Code from the set of Walsh Codes to indicate that open association is leveraged by the base station; and
selecting a second reserved Walsh Code from the set of Walsh Codes to indicate that signaling association is utilized by the base station.

38. The method of claim 35, wherein the selected Walsh Code is assigned to the base station.

39. The method of claim 35, further comprising transmitting a Common Pilot that incorporates a reserved pseudo-noise (PN) offset when the base station is a femto cell base station.

40. A wireless communications apparatus, comprising:
at least one processor configured to:
generate an Auxiliary Pilot based upon a Walsh Code from a Walsh Code space assigned to a base station; and
transmit the Auxiliary Pilot to one or more mobile devices to designate a characteristic of the base station as a function of the assigned Walsh Code.

41. The wireless communications apparatus of claim 40, wherein the Walsh Code space is partitioned to include a first subset of Walsh Codes for femto related use and a second subset of Walsh Codes for non-femto related use.

42. The wireless communications apparatus of claim 40, wherein the characteristic of the base station is at least one of a base station type, an association type of the base station, or a unique identity corresponding to the base station.

43. The wireless communications apparatus of claim 40, further comprising:
at least one processor configured to:
broadcast a Common Pilot that incorporates a reserved pseudo-noise (PN) offset when the base station is a femto cell base station.

44. An apparatus, comprising:
means for obtaining an assigned Walsh Code at a base station;
means for yielding a unique Auxiliary Pilot as a function of the assigned Walsh Code; and
means for transmitting the unique Auxiliary Pilot to one or more mobile devices to identify a characteristic of the base station.

45. The apparatus of claim 44, further comprising means for transferring a Common Pilot with a reserved pseudo-noise (PN) offset to indicate that the base station is a femto cell base station.

46. The apparatus of claim 44, wherein the characteristic of the base station is at least one of a base station type, an association type of the base station, or a unique identity corresponding to the base station.

47. A computer program product, comprising:
a computer-readable medium comprising:
code for causing at least one computer to generate a unique Auxiliary Pilot based upon an assigned Walsh Code, the Walsh Code being assigned as a function of a characteristic of a base station; and
code for causing at least one computer to broadcast the unique Auxiliary Pilot to at least one mobile device to indicate the characteristic.

48. The computer program product of claim 47, wherein the characteristic of the base station is at least one of a base station type, an association type of the base station, or a unique identity corresponding to the base station.

49. The computer program product of claim 47, wherein the computer-readable medium further comprises code for causing at least one computer to transfer a Common Pilot with a reserved pseudo-noise (PN) offset to indicate that the base station is a femto cell base station.

50. An apparatus, comprising:
a common pilot generation component that yields a pilot sequence with a particular pseudo-noise (PN) offset reserved for femto cell base stations for transmission from a base station to at least one mobile device; and
an auxiliary pilot generation component that yields information related to the base station for transmission via a physical layer broadcast channel, the information specifies at least one of the base station is a femto cell base station, an association type of the base station, or a unique identifier of the base station.

51. The apparatus of claim 50, further comprising a code assignment component that dynamically selects a particular Walsh Code from a set of possible Walsh Codes, the particular Walsh Code being the information related to the base station.
